(19) United States
(12) Patent Application Publication
(10) Pub. No.: US 2003/0204748 A1
(43) Pub. Date: Oct. 30, 2003

(54) Auto-detection of wireless network accessibility

(76) Inventor: Tom Chiu, Sunnyvale, CA (US)

Correspondence Address: U.S. Philips Corporation, 580 White Plains Road, Tarrytown, NY, 10591, US

(21) Appl. No.: 10/151,360

(22) Filed: May 20, 2002

Related U.S. Application Data
(60) Provisional application No. 60/377,189, filed on Apr. 30, 2002.

(51) Int. Cl. H04L 9/00

(52) U.S. Cl. 713/201

(57) ABSTRACT

A method and system identifies the particular security protocol required to access each network that a user of a portable device encounters. If a security protocol is required for a network, and the user has the appropriate security key, the system is further configured to identify that key. The system is configured to determine whether a network within range of the device requires encryption, and if so, at what level. If encryption is required, the system accesses a network profile to determine whether the user possesses a key for use in the particular network. The system displays a network identifier, the level of encryption required, and, if available, an identification of the appropriate security key for the identified network. Optionally, the system can be configured to display only those networks that the user can actually access: non-secure networks and secure networks for which an appropriate key is available. If a secure network is selected, the system configures the device to effect the required security, using the identified key.

This application claims the benefit of U.S. Provisional Patent Application, serial No. 60/377,189, filed Apr. 30, 2002, Attorney Docket Number US020132P.

### BACKGROUND OF THE INVENTION

1. Field of the Invention

This invention relates to the field of wireless communication devices, and in particular to a system and method for determining accessibility to wireless networks.

2. Description of Related Art

Wireless networks are becoming increasingly popular for providing communications among portable devices, such as Personal Data Assistants (PDAs), palmtop computers, laptop computers, and the like. Enterprises, such as coffee shops and airlines, are currently providing wireless access points at their locales, to attract customers who desire to ‘keep in touch’ via e-mail and Internet access while away from their office or home network environment. Additionally, methods and systems are available for establishing temporary computer networks for conferences, business meetings, etc., wherein computer devices establish an ad-hoc network and communicate with each other on a peer-to-peer basis.

With the continued proliferation of wireless networks, a user of a portable device is likely to encounter multiple networks on a regular basis. To facilitate the communications with such networks, advanced computer systems, such as Microsoft XP, include tools that ease the task of configuring the device to communicate with each network. Ideally, the device will be configured to connect to a select computer network with minimal intervention by the user. Microsoft XP, for example, includes a “Zero-Config” application for 802.11 b wireless networks that automatically configures a device for communications to a select network with “zero” intervention by the user. The user is provided a list of networks that are currently available to the portable device, typically based on a pilot signal that is transmitted by the network to identify the network. In the 802.11 b protocol, each network has an associated Sub-System Identifier (SSID), which is typically an easy-to-recognize name that identifies the particular network. The received SSIDs are displayed, and the user selects one network from among the available networks. This simple configuration process, however, is effective only for non-secured networks; additional configuration processes must be invoked to connect to a secured network.

To assure that only authorized users access particular networks, security processes are provided in most wireless network protocols. For example, the 802.11 b protocol includes a Sub-System-Identifier (SSID) that is used to identify each network, and each SSID has an associated Wired Equivalent Privacy (WEP) property that indicates whether a secure key is required to access the identified network, and identifies the type (size) of key required. An authorized user of the network is issued a security key, typically by the administrator of the network, and this security key is used to encrypt and decrypt information that is communicated via the wireless network. It is not uncommon for a mobile user to have access to dozens of different wireless networks, some or all of which may require a unique security key. Generally, to avoid having to remember the configuration data required for secured networks, such as an identification of the particular key that is used by each network, most users store the relevant associations that they use in a data structure that is commonly termed a “network profile”. When the user encounters an accessible network, the user searches the network profiles for the identifier of that network, and thereby the corresponding configuration parameters, and if the identifier is in a network profiles, the user instructs the system to apply these corresponding configuration parameters, such as the use of the appropriate security key for this network. If the user fails to configure the system to use the proper key for communicating with a particular network, or configures the system to use a key for communicating with a network that does not use a key, communications with the network will fail, often without any indication of the problem to the user, other than a lack of communications.

### BRIEF SUMMARY OF THE INVENTION

It is an object of this invention to simplify the process of configuring a device for communications via a wireless network. It is a further object of this invention to facilitate the selection of keys for configuring a device for communications via a secure wireless network.

These objects, and others, are achieved by providing a method and system that identifies the particular security protocol required to access each network that a user of a portable device encounters. If a security protocol is required for a network, and the user has a network profile that corresponds to the identifier of the network and identifies the appropriate security key, the system is further configured to identify that key or that profile to the user. The system is configured to determine whether a network within range of the device requires encryption, and if so, at what level. If encryption is required, the system accesses a network profile to determine whether the user possesses a key for use in the particular network, by searching for an entry in the network profiles that corresponds to an identification of the network. The system displays a network identifier, the level of encryption required, and, if available, an identification of the appropriate security key, or the network profile, for the identified network. Optionally, the system can be configured to display only those networks that the user can actually access: non-secure networks and secure networks for which an appropriate key is available. If a secure network is selected, the system configures the device to effect the required security, using the identified key.

### BRIEF DESCRIPTION OF THE DRAWINGS

The invention is explained in further detail, and by way of example, with reference to the accompanying drawings wherein:

FIG. 1 illustrates an example block diagram of a multi-network environment.

FIG. 2 illustrates an example block diagram of an access determination system in accordance with this invention.

FIG. 3 illustrates an example flow diagram of an access determination system in accordance with this invention.

FIG. 4 illustrates an example flow diagram of a network selection process in accordance with this invention.

FIG. 5 illustrates an example flow diagram of a network search process in accordance with this invention.

Throughout the drawings, the same reference numerals indicate similar or corresponding features or functions.

### DETAILED DESCRIPTION OF THE INVENTION

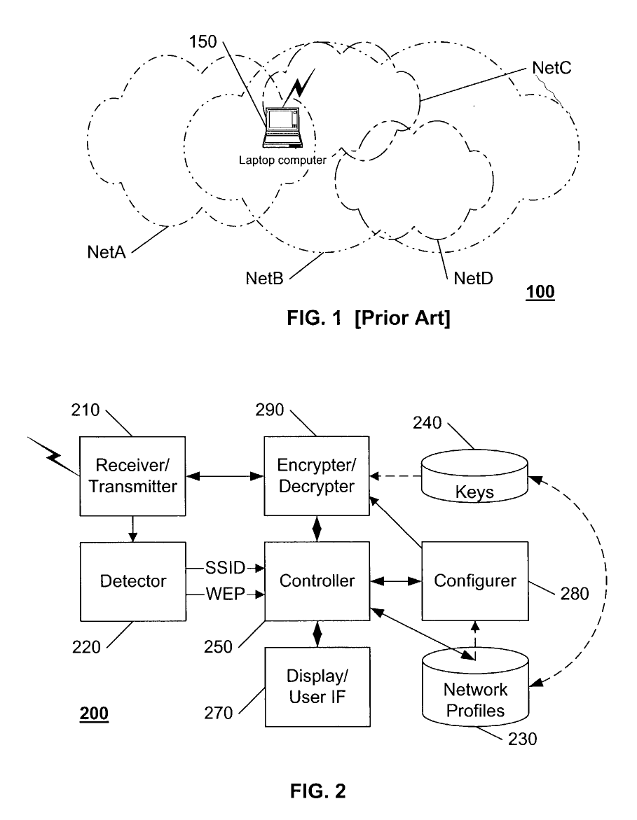

FIG. 1 illustrates an example block diagram of a multi-network environment 100. Illustrated in FIG. 1 are four networks NetA, NetB, NetC, and NetD, and a user device 150. In this example, the device 150 is within the range of NetA, NetB, and NetC, and not within the range of NetD. In a conventional network access system, such as a Windows XP system that includes a “Zero-config” application, the access system in the user device 150 informs the user that NetA, NetB, and NetC are available for use, because they are each in range of the user device 150. The conventional system displays the Sub-System Identifier (SSID) of each of the networks NetA, NetB, and NetC, and the user has the option of clicking upon one of these identifiers to configure the system to communicate with the selected network. However, if the selected network is secured, the user must first provide the appropriate security parameters for configuring the device 150, such as an identification of the security key that is used for encrypting and decrypting communications to and from the selected network. If the user has saved the security parameters in a network profile, the user searches the profile for the identifier of the selected network and its corresponding parameters, and applies these parameters to effect the configuration of the device 150 for securely communicating with the selected network.

When the user selects a particular network, the conventional access system configures the device 150 to subsequently transmit and receive information to the selected network. If the selected network is a secure network, such as an 802.11 b network with an enabled WEP, the device 150 is configured to subsequently encrypt and decrypt the information transmitted to, and received from, the selected network, using the appropriate security key, as discussed above. If the user mistakenly selects a secure network for which the user does not have a proper key, the user device 150 does not properly encrypt or decrypt the information transmitted to, and received from, the selected network, and communication does not occur. Because an improper or missing key precludes communication with the network, the network is, generally, unable to notify the user that a problem exists. As such, the only feedback that the user receives is a lack of communication with the selected network, with no indication that the source of the problem is a missing or improper security key.

In a preferred embodiment of this invention, the user device 150 includes an access system 200, discussed below, that is configured to determine whether each encountered network is secure, and, if so, to determine whether the user is authorized to access the secured network. In accordance with a further aspect of this invention, if the user is authorized to access the secured network, the appropriate key is provided to the encryption/decryption processes for subsequent communication with the secured network. In accordance with a further aspect of this invention, if a network is secure, and the user does not have access rights to this network, the secured network is not included in the list of networks available to the user.

FIG. 2 illustrates an example block diagram of an access determination system 200 in accordance with this invention. For ease of understanding, the system 200 is presented herein using the paradigm of an 802.11 b network, although the principles of this invention are applicable to other networks as well.

A receiver 210 receives transmissions from transmitters in the vicinity of the receiver 210. A network detector 220 is configured to detect transmissions from newly encountered networks; for example, by detecting new pilot signals from a network. As in a conventional detector, the detector 220 is configured to provide an identifier, nominally the SSID, of the network to a controller 250. In accordance with this invention, the detector 220 is also configured to provide an indication of whether the network is secure. In the paradigm of an 802.11 b network, the indication of security is provided by the Wired Equivalent Privacy (WEP) flag.

If the indicator indicates that the network is not secured, the controller 250 operates as a conventional wireless network access device, and informs the user that a new, and accessible, network has been encountered, via the display device 270. If the user selects this network, the controller 250 activates a conventional configurer 280 to communicate with this network.

If, on the other hand, the indicator indicates that the network is secured, the controller 250 informs the user of this fact, thereby warning the user not to connect to the network without the appropriate security key.

In a preferred embodiment of this invention, the controller 250 is also configured to determine whether the user is authorized to access the network, and, if so, to identify the appropriate key 240 for this network. In a straightforward embodiment of this aspect of the invention, the controller 250 accesses a set of network profiles 230 that contains an identification of all of the secured networks to which the user has access. Such a profile 230 may be created and manually updated by the user each time the user is granted access to a network, and/or it may be updated automatically by the applications that the user uses to create or obtain the key to each network, and/or it may be updated automatically by the controller 250, as discussed below.

Preferably, each network profile 230 contains an SSID, and a corresponding identifier of the location of the security key 240 for this SSID, such as the file name of the key. This file name, or the name of the network profile 230, is displayed with the SSID, to aid the user in appropriately configuring the user's device for communication with each network.

In accordance with another aspect of this invention, when the user selects a particular SSID, the controller 250 automatically transfers the identification of the appropriate security key 240 to the configurer 280. The configurer 280 communicates this identification to an encryption/decryption device 290, for subsequent encryption and decryption of communications to and from the selected wireless network. In this manner, the system 200 of this invention reliably effects communication with secured networks to which the user has access. If the network profile 230 indicates that there is no key associated with the selected network, or if there is no network profile 230 corresponding to the selected network, the controller 250 warns the user, and allows the user to specify the appropriate key and/or appropriate network profile identifier. If the user specifies a key, the controller 250 creates or updates a network profile 230 with this association, and proceeds to activate the configurer 280, as detailed above.

In accordance with another aspect of this invention, the controller 250 may be configured to minimize the distractions to a user by not displaying the SSID of encountered networks to which the user does not have access. As wireless networks become more prolific, this option provides an effective filtering between available networks and accessible networks.

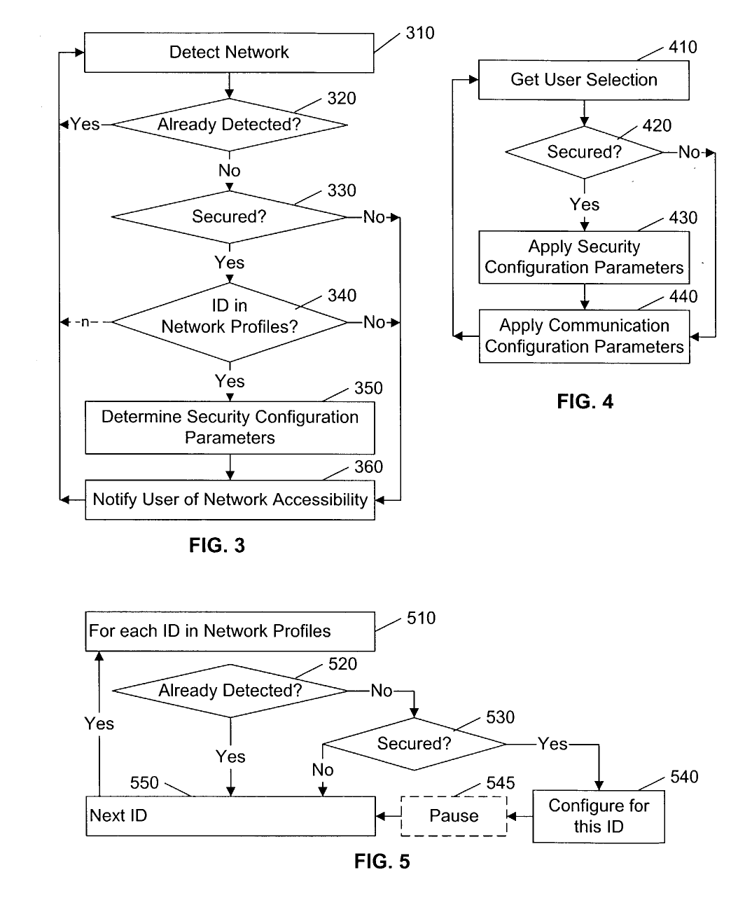

The flow diagrams of FIGS. 3-5 are provided to further present aspects of a preferred embodiment.

FIG. 3 illustrates an example flow diagram of an access determination system in accordance with this invention. The flow is illustrated as a continuous loop 310-360, although the system could be configured as an on-demand process. At 310, a network is detected, typically via receipt of a pilot signal that is transmitted from the network. Alternatively, the system may be configured to transmit a “prompt” signal, to which a network is configured to respond. At 320, the identifier of the network, determined from the detected transmission of the network, is compared to prior identifiers of detected networks, to determine if this network has already been detected. If the network has already been detected, the process returns to 310 to detect other transmissions.

In accordance with this invention, the system is configured to determine whether the newly detected network is secured, at 330. If it is not secured, the process operates consistent with conventional network detection systems by merely notifying the user that the network is accessible, at 360. If, at 330, the network is determined to be secured, the identifier of the network is compared to entries in the network profile, at 340, to determine if the user has recorded the configuration parameters, and in particular the security parameters, necessary to establish communication with this network.

If, at 340, the network identifier is found in the network profile, the configuration parameters, such as the name of the file that contains the security key, are determined from the contents of the network profile, at 350, and the user is notified that this network is accessible, at 360. If, at 340, the network identifier is not found in the network profile, either of two options can be used. As illustrated by the solid arrow from 340, the process may be configured to report the fact that the network is within range of the receiving device, but not accessible due to the lack of appropriate configuration information, at 360. Alternatively, as illustrated by the dashed arrow from 340, the process may be configured to foreshorten the loop 310-360 by branching directly back to 310, thereby effectively ignoring each inaccessible network, by not reporting the presence of such networks to the user.

Because inaccessible networks are either reported as such, or not reported, the likelihood of a user mistakenly attempting to connect with an inaccessible network is minimized. Similarly, because accessible networks are identified as being either unsecured or secured, the likelihood of a user mistakenly attempting to connect to an accessible secured network without first configuring the system for secure communications with the secured network is also minimized.

FIG. 4 illustrates an example flow diagram of a network selection process in accordance with this invention. At 410, the user selects the network to which to connect, typically by selecting the network identifier from a list of accessible networks, such as provided by block 360 of FIG. 3. If, based on the determinations discussed above with regard to FIG. 3, the network identifier corresponds to a secured network, at 420, then the security configurations are applied, at 430, based on the parameters that were determined for the selected network at 350 in FIG. 3. Thereafter, or concurrently, the communication parameters required for configuring the device to communicate with the selected network are applied, at 440. If, at 420, the network is not a secured network, the system is configured to bypass the block 430, and operates as a convention network configuration system, by applying the aforementioned communication parameters, at 440. By automatically configuring the system for communicating with accessible secured networks, the likelihood of a user mistakenly attempting to access a secure network without the appropriate security configuration is minimized.

FIG. 5 illustrates an example flow diagram of a network search process in accordance with this invention. As noted above, most networks periodically transmit pilot signals that announce the network's presence in an area. If the network is secured, this pilot signal will generally be communicated using an unsecured transmission scheme, so that any device in the vicinity of the network is able to determine the network identifier that is associated with this secured network. Other secured networks assume that only devices that are configured for use in the network need to be informed of the presence of the network. The process of FIG. 5 allows a user device to search for each network to which the user has permitted access.

The process of FIG. 5 sequentially determines whether each of the networks that are contained in the user's profile is currently accessible, via the loop 510-550. If, at 520, the particular network has already been detected, the loop sequences to the next network in the network profile, via 550. If the currently evaluated network has not yet been detected, at 520, the characteristics of the network in the network profile are assessed to determine whether this network is a secured network, at 530. If the network is not a secured network, it is ignored, and the loop sequences to the next network, via 550. If, at 530, it is a secured network, the user's device is configured with the configuration parameters associated with this network, and specifically, configured to provide the appropriate security processing of the received transmissions, at 540.

While the process of FIG. 5 is invoked, the above described access determination process of FIG. 3 is also invoked. Thus, when the device is configured for the currently evaluated secured network at 540 in FIG. 5, the process of FIG. 3 will be able to detect the pilot signal from this secured network. If necessary, a pause may be introduced to the process of FIG. 5, at 545, to allow the process of FIG. 3 sufficient time to detect the secured network, if it is present. Thereafter, the loop of FIG. 5 sequences to the next network, via 550. Not illustrated, when the process of FIG. 5 terminates, the user device is configured for communicating with non-secured networks, thereby allowing the process of FIG. 3 to detect the non-secured networks.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. An access determination system comprising:
a detector that is configured to detect a network within a vicinity of a user device, the network having a network identifier and a security indicator, and
a controller, operably coupled to the detector, that is configured to receive the network identifier and the security indicator, and thereupon facilitate a configuration of the user device for communication via the network, based on the network identifier and the security indicator.

2. The system of claim 1, further including
a user interface device;
wherein
the controller facilitates the configuration by communicating one or more messages via the user interface device based on the network identifier and the security indicator.

3. The system of claim 1, further including
a configurer that is configured to configure the user device for communication via the network;
wherein
the controller facilitates the configuration by controlling the configurer based on, the network identifier and the security indicator.

4. The system of claim 3, wherein
the configurer is further configured to enable an encryption and decryption of communications via the network, based on the security indicator.

5. The system of claim 4, wherein
the encryption and decryption includes the use of a security key, and
the controller is further configured to facilitate a determination of the security key for the network.

6. The system of claim 1, further including
network profiles that are configured to contain one or more network identifications and associated key identifications;
wherein
the controller is configured to facilitate the configuration of the user device based on a correspondence between the network identifier and one of the one or more network identifications and associated key identifications.

7. The system of claim 6, wherein
the associated key identifications include an identification of a security key that is associated with the network identifier.

8. The system of claim 7, further including
a cryptographic device;
wherein
the controller is further configured to facilitate the configuration of the user device by effecting communication of the identification of the security key to the cryptographic device.

9. The system of claim 6, wherein
the controller is further configured to inhibit the configuration of the user device if the correspondence between the network identifier and the one or more network identifications does not exist.

10. A user device that is configurable for communication to a select network of a plurality of networks, each network of the plurality of networks being identified by a network identifier, the user device comprising:
a receiver that is configured to receive transmissions from devices within the plurality of networks,
a detector, operably coupled to the receiver, that is configured to identify each network of the plurality of the network from which the transmissions were received, based on a received network identifier from each network, and
a controller, operably coupled to the detector, that is configured to:
provide a notification of each network from which the transmissions were received,
detect a user selection of the select network, based on the notification, and
facilitate a configuration of the user device to effect communication with the select network;
wherein
the detector is further configured to identify a security indicator that is associated with each network, and
the controller facilitates the configuration based also on the security indicator.

11. The user device of claim 10, wherein
the notification of each network includes the security indicator.

12. The user device of claim 10, wherein
the controller is further configured to determine a security key associated with each network, based on a stored association of the received network identifier and an identification of the security key.

13. The user device of claim 12, wherein
the notification of each network includes the identification of its associated security key.

14. The user device of claim 12, further including
a cryptographic device that is configured to encrypt and decrypt communications to and from the select network;
wherein
the controller is further configured to communicate the identification of the select network's associated security key to the cryptographic device.

15. A method of determining accessibility for communications to a network, comprising:
detecting a transmission from a device associated with the network,
determining a network identifier associated with the network,
determining a security indicator associated with the network,
determining the accessibility for communications to the network based on the network identifier, the security indicator, and a plurality of network profiles.

16. The method of claim 15, wherein
the plurality of network profiles includes one or more network identifications and associated key identifications; and
determining the accessibility includes
determining a correspondence between the network identifier and one of the one or more network identifications and associated key identifications.

17. The method of claim 16, further including
providing an identification of a security key to a cryptographic process,
the identification of the security key corresponding to the associated key identifications of the one or more network identifications that corresponds to the network identifier.

18. The method of claim 15, further including
providing a notification of the network identifier based on the accessibility to the network.
